(19) United States
(12) Patent Application Publication
(10) Pub. No.: US 2021/0386193 A1
(43) Pub. Date: Dec. 16, 2021

(54) Furniture systems and method for carrying out a local fault diagnosis and optionally an expanded remote fault diagnosis for at least one electrically height-adjustable table and various Systems and Methods for Automatically Adjusting the Height of the Table Top of an Electrically Height-Adjustable Table

(71) Applicant: Oelschläger Metalltechnik GmbH, Hoya/Weser (DE)

(72) Inventor: Thibaud Bucquet, Bremen (DE)

(73) Assignee: Oelschläger Metalltechnik GmbH, Hoya/Weser (DE)

(21) Appl. No.: 17/287,453

(22) PCT Filed: Oct. 16, 2019
(86) PCT No.: PCT/DE2019/100898

§ 371 Date: Apr. 21, 2021

(30) Foreign Application Priority Data
Oct. 22, 2018 (DE) 10 2018 008 309.9

(51) Int. Cl. A47B 9/00

(52) U.S. Cl. CPC A47B 9/00; A47B 2200/0061; A47B 2200/0056

(57) ABSTRACT

A furniture system with an electrically height-adjustable table which has at least one electrically height-adjustable frame, in particular an electrically height-adjustable table leg, with at least one electric motor via which a height adjustment of the table top is possible, and a motor control device for controlling the at least one electric motor as well as at least one sensor device for temporally detecting a value of at least one motor characteristic of the at least one electric motor, a communication module with a control and evaluation device, which is coupled to the at least one sensor device, for evaluating the values of the at least one motor characteristic, which values are detected by means of the at least one sensor device, with regard to a deviation from a respective motor characteristic reference value, which communication module is coupled to the motor control device via a data connection, and a remote computer, in particular server, preferably with a web interface, which can be connected to the communication module via a data network and has a data storage device as well as means for expanded remote fault diagnosis for the at least one electrically height-adjustable table.

The present invention relates to a furniture system with an electrically height-adjustable table which has at least one electrically height-adjustable frame, in particular an electrically height-adjustable table leg, with at least one electric motor via which a height adjustment of the table top is possible, and a motor control device for controlling the at least one electric motor, a method for carrying out a local fault diagnosis and optionally an expanded remote fault diagnosis for at least one electrically height-adjustable table which has at least one electrically height-adjustable frame, in particular an electrically height-adjustable table leg, with at least one electric motor via which a height adjustment of the table top is possible, and a motor control device for controlling the at least one electric motor, a system for detecting the utilization of workstations with, preferably electrically height-adjustable, tables, a system for allocating a free workstation which corresponds to user requests with a, preferably electrically height-adjustable, table, a system for automatically setting user-specific settings for a workstation with a, preferably electrically height-adjustable, table, a furniture system with an electrically height-adjustable table which has at least one electrically height-adjustable frame, in particular an electrically height-adjustable table leg, with at least one electric motor via which a height adjustment is possible, and a motor control device for controlling the at least one electric motor, as well a method for automatically adjusting the height of the table top of an electrically height-adjustable table, which has an electrically height-adjustable table, which has at least one electrically height-adjustable frame, in particular an electrically height-adjustable table leg, with at least one electric motor via which a height adjustment is possible, and a motor control device for controlling the at least one electric motor, when a user changes position from a standing position to a sitting position, or vice versa.

Work tables, in particular office desks and office desk systems, are known in many forms. Sitting/standing systems are becoming increasingly common in modern offices. This also applies for the “smart office” technology and the “Internet of Things”.

Within the context of in particular electrically height-adjustable tables, there is a need for predictive remote maintenance, preferably in combination with an initial simple fault diagnosis and troubleshooting. Moreover, the detection of space utilization or table utilization is of interest for data-driven office and building planning.

In addition, so called “coworking spaces” are becoming increasingly interesting for start-ups, small businesses and freelancers. Coworking spaces are both offices and points of exchange. However, coworking spaces are also advantageous in open-plan offices, for example, since they allow the flexibility of working occasionally and/or alternately, for example in the case of varying project groups. Within this context but also within the context of other working concepts, simple remote booking of workstations or tables would also be advantageous.

In the case of electrically height-adjustable tables, the table height (table top height) currently still has to be manually adjusted by a user by actuating an operating element when changing position from a sitting position to a standing position, and vice versa. This can be very uncomfortable. There is therefore also the need for an automatic table height adjustment for position changes of this type.

According to a first aspect, the present invention provides a furniture system with
an electrically height-adjustable table which has at least one electrically height-adjustable frame, in particular an electrically height-adjustable table leg, with at least one electric motor via which a height adjustment of the table top is possible, and a motor control device for controlling the at least one electric motor as well as at least one sensor device for temporally detecting a value of at least one motor characteristic of the at least one electric motor,
a, preferably permanently installed, communication module with a the at least one sensor device detected values of the at least one motor characteristic with regard to a deviation from a respective motor characteristic reference value, which communication module is coupled to the motor control device via a data connection, and
a remote computer, in particular server, preferably with a web interface, which can be connected to the communication module via a data network and has a data storage device as well as means for expanded remote fault diagnosis for the at least one electrically height-adjustable table,
wherein the motor control device is coupled to the at least one sensor device and is set up to store the detected values of the at least one motor characteristic, and wherein the control and evaluation device is set up to evaluate the currently detected value in each case of the at least one motor characteristic with regard to a deviation from a respective motor characteristic reference value and, if the determined deviation exceeds a predeterminable threshold value, to check the temporal course of the detected values, to categorize any fault which is found and to store the fault category locally and optionally to transfer it to the local display as well as to send a fault diagnosis report together with the temporal course of the detected values of the at least one motor characteristic to the data storage device in the remote computer for storing and for carrying out an expanded remote fault diagnosis.

The communication module is preferably permanently installed, in particular not separate or mobile. The communication module is preferably installed in the housing for the motor control device or in the manual switch, for example.

According to a second aspect, the present invention provides a method for carrying out a local fault diagnosis and optionally an expanded remote fault diagnosis for at least one electrically height-adjustable table which has at least one electrically height-adjustable frame, in particular an electrically height-adjustable table leg, with at least one electric motor via which a height adjustment of the table top is possible, and a motor control device for controlling the at least one electric motor as well as at least one sensor device, which is coupled to the motor control device, for temporally detecting a value of at least one motor characteristic of the at least one electric motor, wherein the method comprises the steps:
temporally detecting values of at least one motor characteristic of the at least one electric motor by means of at least one sensor device and storing the detected values of the at least one motor characteristic in the motor control device,
evaluating the currently detected value in each case of the at least one motor characteristic with regard to a deviation from a respective motor characteristic reference value by means of a control and evaluation device, which is coupled to the motor control device, of a communication module in the region of the table, and
if the determined deviation exceeds a predeterminable threshold value, carrying out, by way of the control and evaluation device, a check of the temporal course of the detected values, categorizing any fault which is found and storing the fault category locally and optionally transferring it to the local display as well as sending a fault diagnosis report together with the temporal course of the detected values of the at least one motor characteristic to a data storage device in a remote computer for storing and for optionally carrying out an expanded remote fault diagnosis, optionally sending a command signal for carrying out an expanded remote fault diagnosis to the remote computer by means of the communication module and
after carrying out the expanded remote fault diagnosis, carrying out remote maintenance and/or troubleshooting.

According to a third aspect, the present invention provides a system for detecting the utilization of workstations with, preferably electrically height-adjustable, tables, comprising
means for detecting the use of the workstation and
an evaluation unit for calculating the utilization of the workstations.

Moreover, according to a fourth aspect, the present invention provides a system for allocating a free workstation which corresponds to user requests with a, preferably electrically height-adjustable, table, comprising
means for detecting the use of the workstations,
means for detecting the respective workstation equipment, in particular features of the workstation equipment, and/or for detecting environmental parameters, such as air quality, brightness, noise, temperature and humidity, for example, of the respective workstation,
means for inputting user requests with regard to the properties of a workstation,
means for comparing the user requests with the respective workstation equipment and/or environmental parameters and allocating a free workstation which most closely approximates the user requests.

Furthermore, according to a firth aspect, the present invention provides a system for automatically setting user-specific settings for a workstation with a, preferably electrically height-adjustable, table, comprising
a means for establishing a user profile relating to user-specific settings for a workstation and optionally also user properties,
a means for reading data relating to the identity of a user and
a means for automatically performing user-specific settings corresponding to the user profile which belongs to the identified user.

In particular, there is also the possibility to transmit one single movement command to a plurality of tables, from which a table group is newly formed, for example if all tables in one space are to be moved upward to assist a cleaner or if a group of four tables, for example, are to be moved to the same height in order to provide a larger workstation, for example for a meeting or project work.

According to a sixth aspect, the present invention provides a furniture system with
an electrically height-adjustable table which has at least one electrically height-adjustable frame, in particular an electrically height-adjustable table leg, with at least one electric motor via which a height adjustment is possible, a motor control device for controlling the at least one electric motor and a radio communication module which is connected to the motor control device,
an associated chair with a, preferably 3-axis, acceleration sensor as well as an evaluation unit connected thereto for evaluating the temporal course of the acceleration, which is detected by means of the acceleration sensor, in the vertical direction, for determining whether a user has sat down on the chair or has stood up from it, and a radio communication module, which is connected to the evaluation unit, for sending a command signal to the motor control device via the communication module of the table, wherein the command signal serves to automatically raise the table top if the evaluation has shown that the user has changed from a sitting position to a standing position, and serves to automatically lower the table top if the evaluation has shown that the user has changed from a standing position to a sitting position. Finally, according to the seventh aspect, the present invention provides a method for automatically adjusting the height of the table top of an electrically height-adjustable table, which has at least one electrically height-adjustable frame, in particular an electrically height-adjustable table leg, with at least one electric motor via which a height adjustment is possible, a motor control device for controlling the at least one electric motor and a communication module which is connected to the motor control device, when a user changes position from a standing position to a sitting position, or vice versa, wherein the method comprises:
detecting the acceleration of a chair which is associated with the table,
evaluating the temporal course of the detected acceleration in the vertical direction for determining whether a user has sat down on the chair or has stood up from it, and
sending a command signal to the motor control, wherein the command signal includes that the table top should be automatically raised if the evaluation has shown that the user has changed from a sitting position to a standing position, and the command signal includes that the table top should be automatically lowered if the evaluation has shown that the user has changed from a standing position to a sitting position.

In the case of the furniture system according to the first aspect of the present invention, provision can be made for the data network to be a public network, an intranet and/or the internet.

According to one particular embodiment, the participant is a computer and/or a mobile device, in particular mobile phone or tablet PC.

Advantageously, the communication module is set up to lock or to unlock at least one functionality of the table, in particular depending on at least one criterion.

Moreover, provision can be made for the communication module to be set up to check the availability of firmware updates for the motor control device and/or for connected peripheral devices and to transmit firmware updates to the motor control device and/or in a wireless manner to the peripheral devices.

Advantageously, the communication module is set up to ensure that usage and height data from the table and/or utilization data of the table are stored in the data storage device of the remote computer.

According to one further particular embodiment, the communication module is set up to retrieve booking data relating to the table from the data storage device of the remote computer.

Advantageously, the communication module has at least one radio interface, such as a WLAN, Bluetooth, Zigbee and NFC interface, for example, for communicating with peripheral devices and for communicating with a participant of the data network via the data network.

In addition, provision can be made for the sensor device to further have at least one sensor for detecting air quality and/or at least one sensor for detecting brightness and/or at least one sensor for detecting noise and/or at least one sensor for detecting temperature and/or at least one sensor for detecting humidity in the environment of the table.

The communication module can be contained in the motor control device or be arranged in a housing in which the motor control device is contained.

Alternatively, the communication module can be contained in an operating device for height adjustment, in particular a manual switch, or be arranged in a housing in which the operating device is contained.

Advantageously, the operating device has a display, preferably with a high resolution, for displaying the fault category and/or a fault diagnosis report and/or the table height and/or a reminder of the setting of an ergonomic sitting or standing position and/or a reminder of a position change from sitting to standing and vice versa and/or the detected air quality and/or the detected brightness and/or the detected noise and/or the detected temperature and/or the detected humidity in the environment of the table. The high resolution can be 128×64 pixels, for example.

Advantageously, the operating device has an NFC reader for reading an authorization means for a user to use a table.

In the case of the method according to the second aspect of the present invention, provision can further be made for it to comprise locking or unlocking a functionality of the table, in particular depending on at least one criterion, such as reaching a predeterminable degree of wear or the occurrence of a reduced or faulty function of the table, for example.

Conveniently, the method further comprises checking the availability of firmware updates for the motor control device and/or for connected peripheral devices and transmitting firmware updates to the motor control device and/or in a wireless manner to the peripheral devices.

The system according to the third aspect of the present invention can further comprise means for detecting environmental parameters, such as air quality, brightness, noise, temperature and humidity in the environment of the table, for example, of the respective workstation and/or means for detecting the respective workstation equipment, in particular features of the workstation equipment.

Advantageously, it further comprises means for subdividing the workstations into categories.

One further particular embodiment also comprises means for detecting the type of usage of the respective workstation, such as the use of the respective table when sitting or when standing, for example, optionally also the temporal proportions of the respective use.

In the case of the system according to the fourth aspect of the present invention, the user requests can also comprise a date and a time period.

Advantageously, allocation comprises a reservation.

Conveniently, the system further comprises means for subdividing the workstations into categories.

Advantageously, for each workstation there is a means for checking the authorization of the use of the respective workstation.

In the case of the furniture system according to the sixth aspect of the present invention, provision can be made for the evaluation device to be set up to send a warning signal to the communication module of the table via the radio communication module if the evaluation of the data from the acceleration sensor has determined a non-authorized movement of the chair, and the table or the furniture system has a warning device for outputting an optical and/or acoustic warning message upon receiving the warning signal from the chair.

Advantageously, the acceleration sensor or a further sensor device is set up to detect the duration of the sitting position, and the evaluation device is set up to send a position change indication signal to the radio communication module of the table if the evaluation of the data from the acceleration sensor or the further sensor device has shown that the duration of the sitting position has exceeded a predeterminable temporal threshold value, and the table or the furniture system has a position change indicator for outputting an optical and/or acoustic position change indication upon receiving the position change indication signal from the chair.

Further features and advantages of the invention are derived from the attached claims and the subsequent description of exemplary embodiments with reference to the schematic drawings. In the drawings:

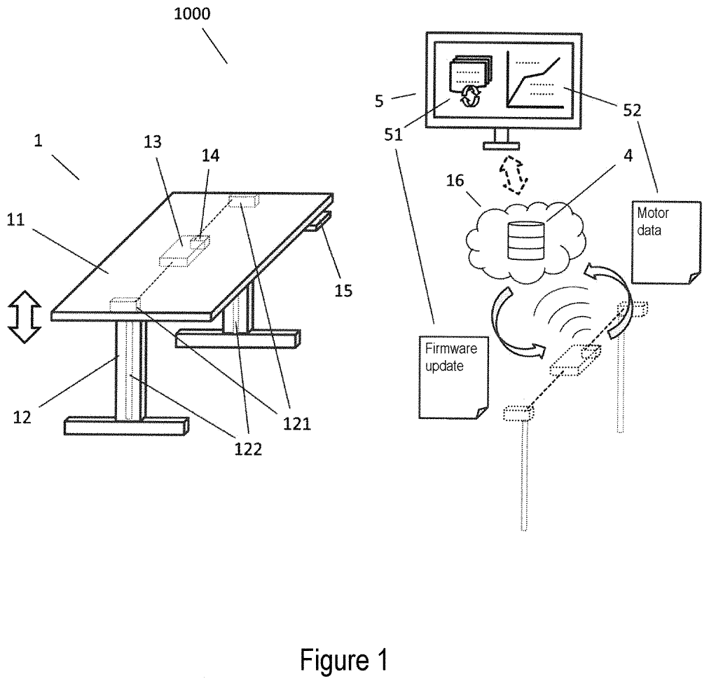

FIG. 1 shows a furniture system according to one particular embodiment of the invention in a perspective view (left) with explanations (right);

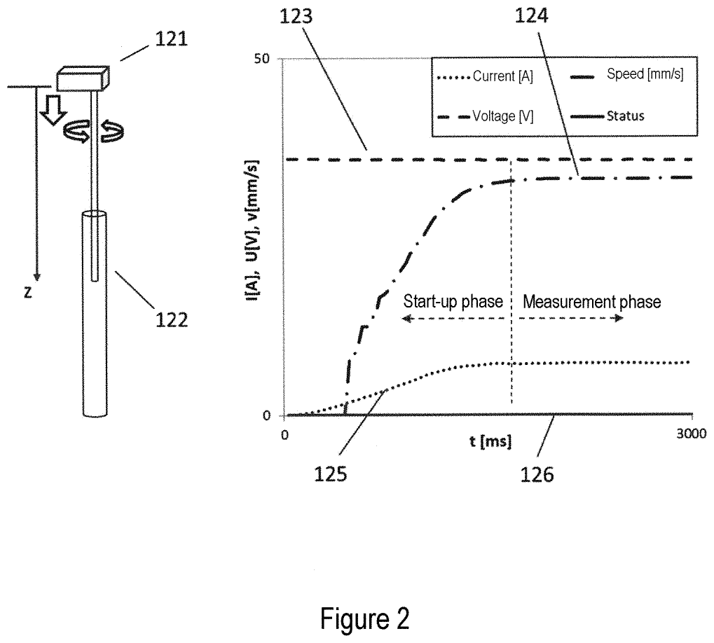

FIG. 2 shows a perspective view of a drive of a height-adjustable table leg (left) and current, voltage and speed curves depending on the time during proper operation (right);

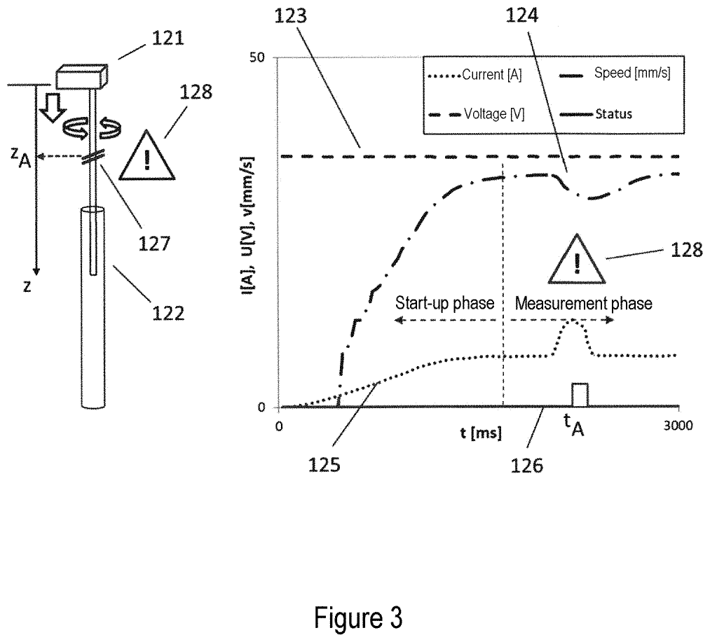

FIG. 3 shows a perspective view of a drive of a height-adjustable table leg (left) and current, voltage and speed curves depending on the time during an operation which deviates from proper operation (right);

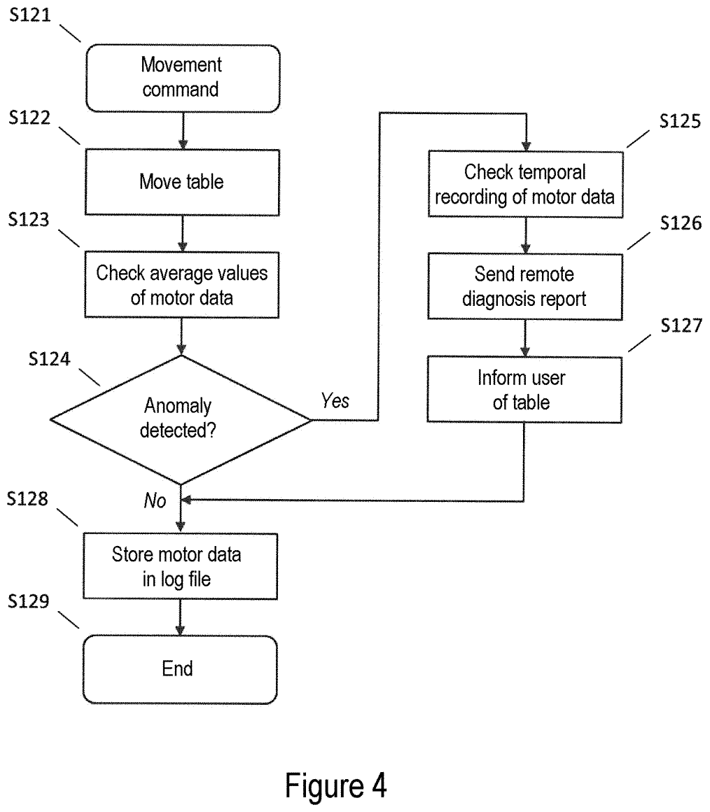

FIG. 4 shows a flow diagram for a method for carrying out a local fault diagnosis and optionally an expanded remote fault diagnosis according to one particular embodiment of the present invention;

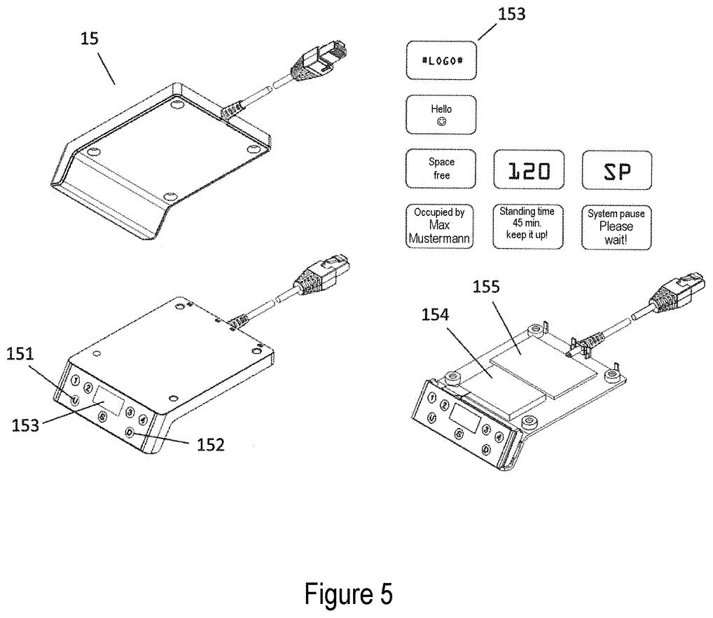

FIG. 5 shows a perspective view obliquely from below (top left), a perspective view obliquely from above (bottom left) and a perspective view from above with a removed housing cover from a manual switch (bottom right), as well as details of a display of the manual switch (top right);

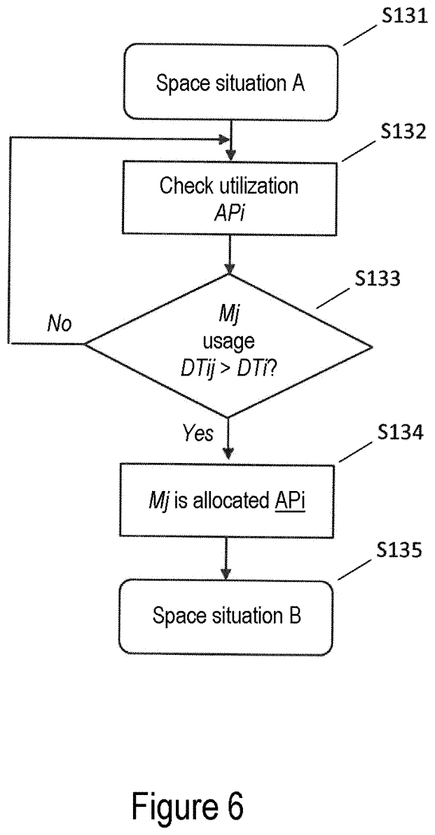

FIG. 6 shows a flow diagram of a method for allocating workstations in a data-driven manner according to one particular embodiment;

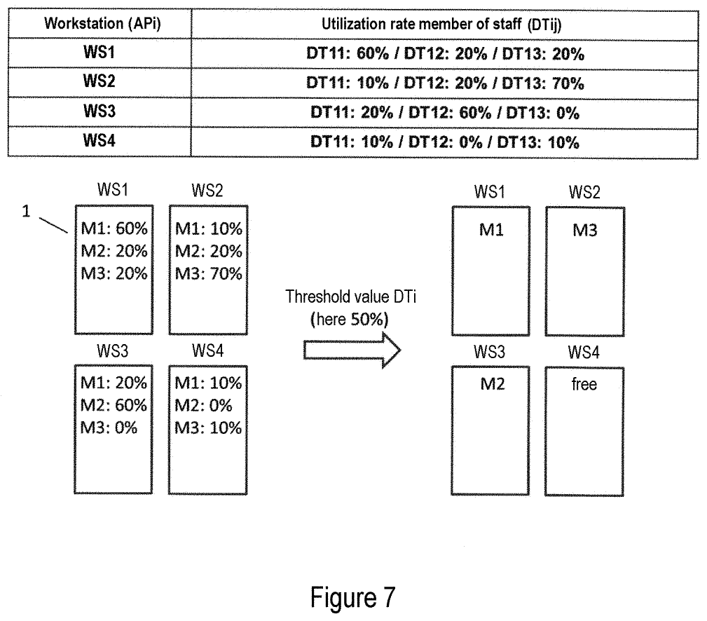

FIG. 7 shows an example of allocating workstations in a data-driven manner for a group of four tables and three people by evaluating the utilization of the workstation;

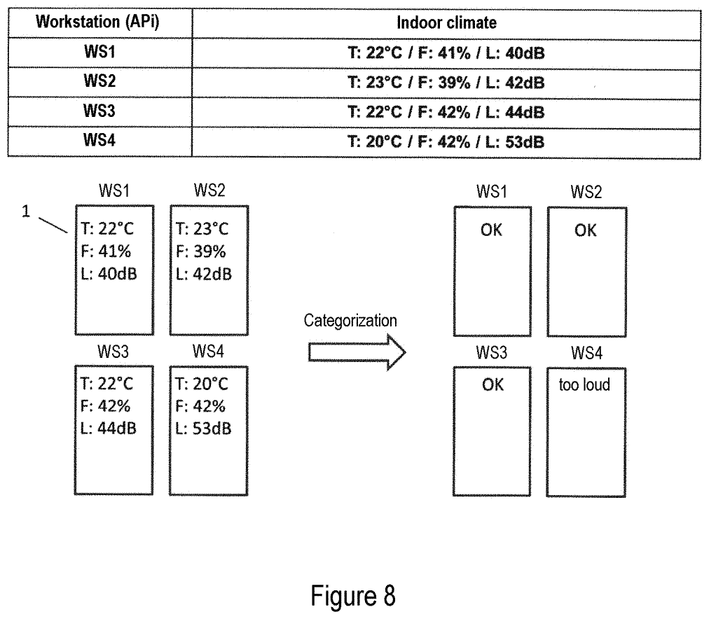

FIG. 8 shows an example of filtering workstations in a data-driven manner by means of evaluating the sound pressure level;

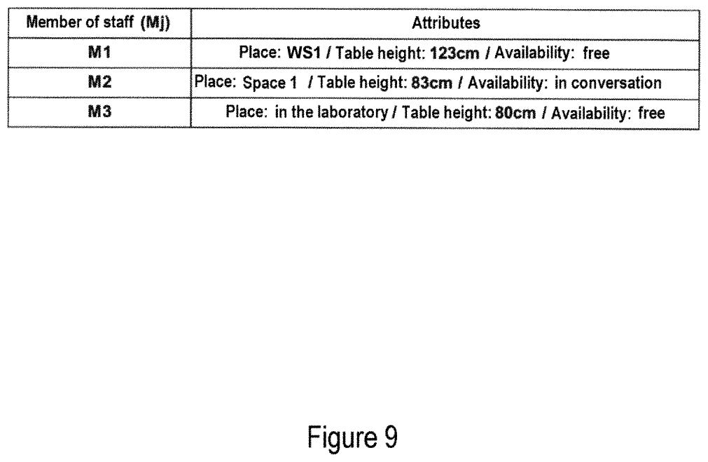

FIG. 9 shows an example of the attributes of a member of staff at an allocated workstation;

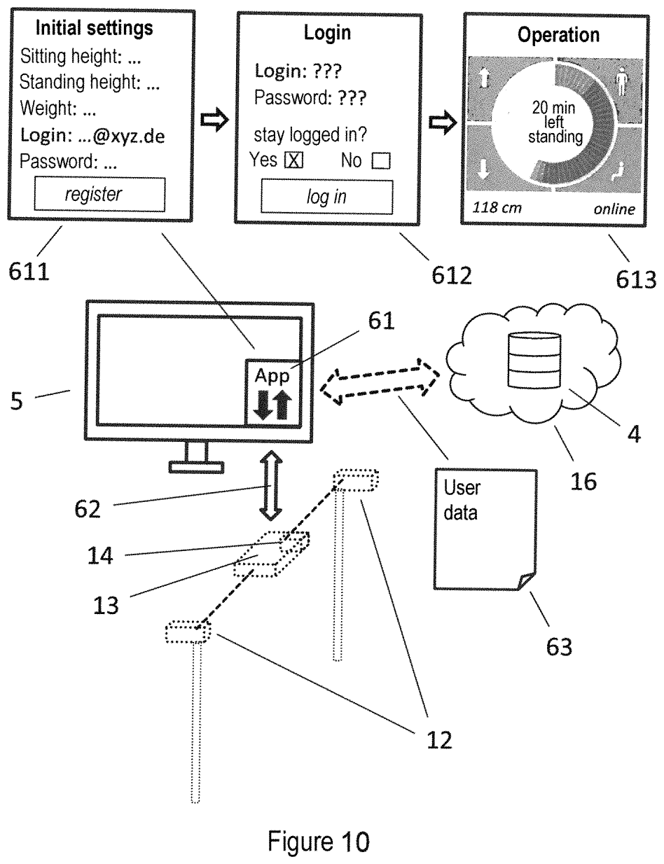

FIG. 10 shows a perspective view of a drive of a height-adjustable table leg (below) with explanations of an exemplary data communication (right) and the software operation (above);

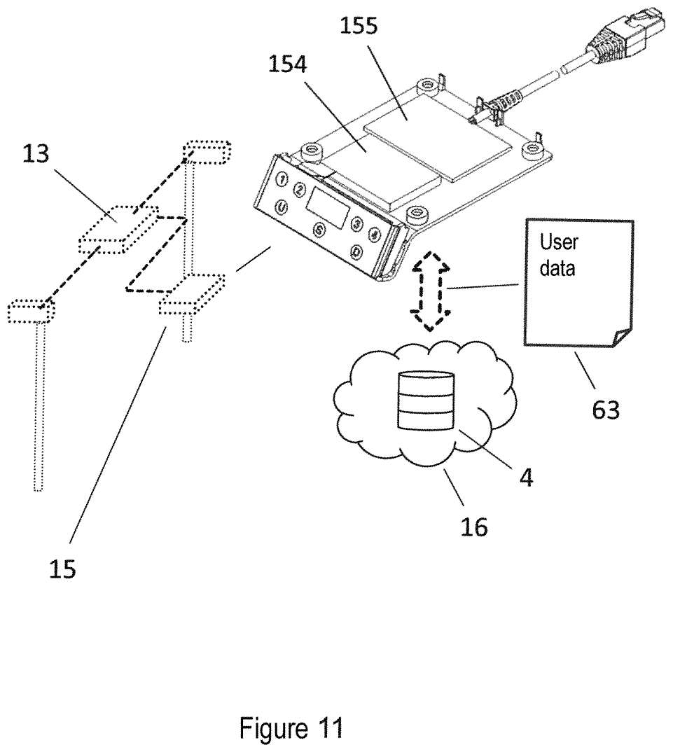

FIG. 11 shows a perspective view of a drive of a height-adjustable table leg (left) with explanations of an exemplary data communication between an operating device and a cloud database (right);

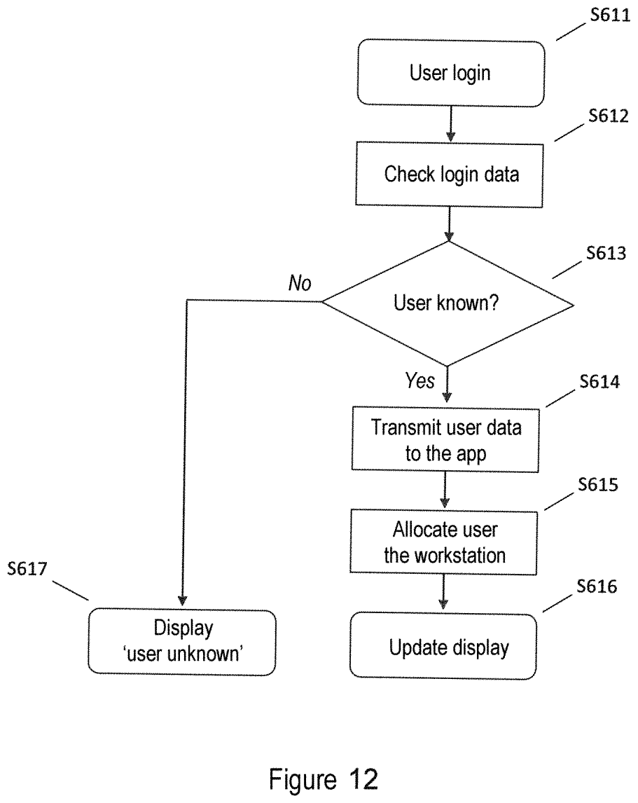

FIG. 12 shows a flow diagram relating to an exemplary method for user login;

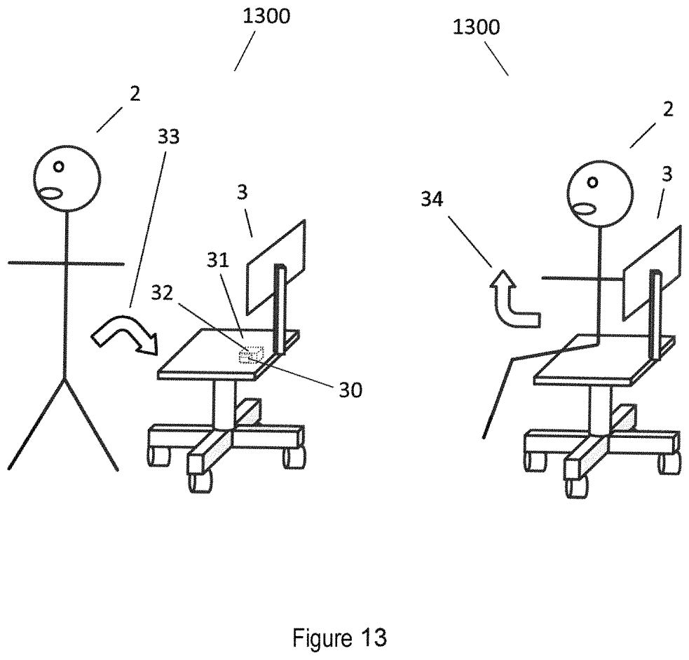

FIG. 13 shows a perspective view of a chair which is associated with a furniture system according to one particular embodiment of the present invention before a user sits down on it (left) and after a user has sat down on it and is standing up again (right);

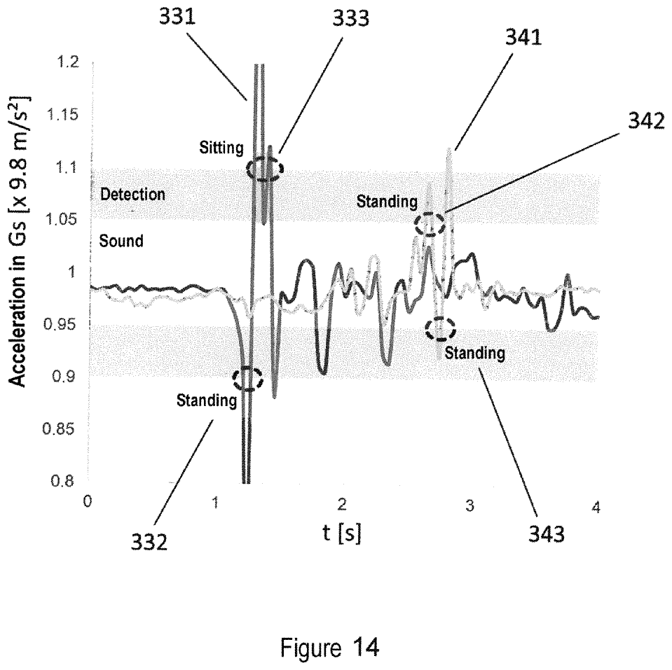

FIG. 14 shows an exemplary diagram of the acceleration, which is measured by means of an acceleration sensor, in the vertical direction, depending on the time of sitting down and of standing up; and

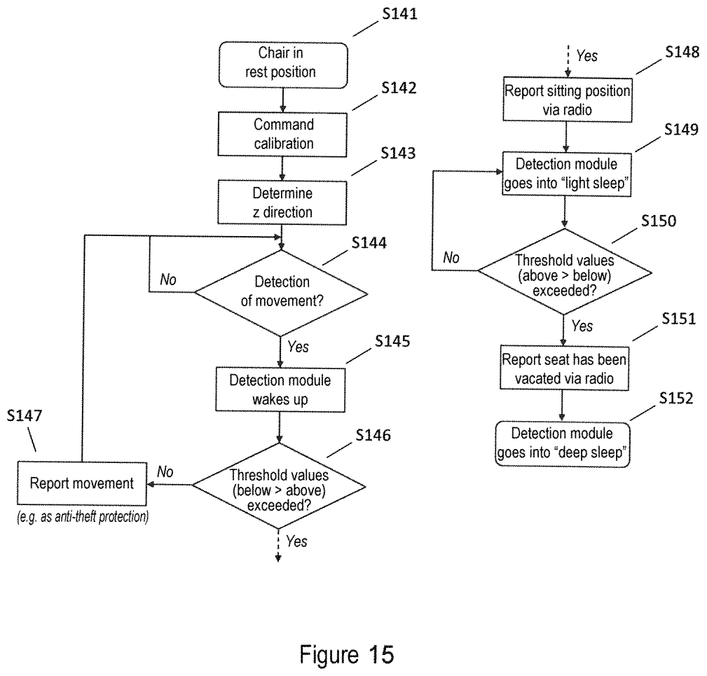

FIG. 15 shows a flow diagram relating to a method for detecting a movement of a chair, in particular if a user is sitting on it and stands up or is standing and sits down on it.

The furniture system 1000 shown in FIG. 1 comprises an electrically height-adjustable table 1 with two electrically height-adjustable table legs 12, an electric motor 121 per table leg 12 for height adjustment of the table top 11, a motor control device 13 for controlling the two electric motors 121 as well as a sensor device 17, which is coupled to the motor control device 13 (see FIGS. 2 and 3), for temporally detecting a value of at least one motor characteristic for each electric motor 121. The motor control 13 also serves to store the detected values of the at least one motor characteristic.

Moreover, the furniture system 1000 comprises a communication module 14 with a control and evaluation device for evaluating the values of the at least one motor characteristic, which values are detected by means of the sensor device 17, with regard to a deviation from a respective motor characteristic reference value, which communication module is coupled to the motor control device 13 via a data connection which can be wired or wireless.

Furthermore, the furniture system 1000 comprises a remote computer, in particular server, with a web interface and a browser interface, which is connected to the communication module 14 via a data network 16, in this example the internet. In FIG. 1, only a data storage device 4 is visible from the remote computer. The computer also has means for expanded remote fault diagnosis for the electrically height-adjustable table 1. Of course, a plurality of electrically height-adjustable tables can also be connected to the remote computer.

The fault diagnosis can take place, for example, via the motor current consumption of the electric motor/electric motors. For example, an average value and a standard deviation can be formed and compared with “standard values”. Depending on the size of the deviation, a temporal course of the motor current consumption is retrieved, in order to be able to carry out a more precise analysis and diagnosis.

For example, pulses from Hall sensors can determine the rotational speed of the electric motor or the electric motors, in order to calculate the travelling speed of the table top. This makes it possible to assess the stability/regularity of the movement of the table and to identify specific “defects” locally via the temporal motor current consumption.

Alternative non-destructive testing methods, such as radiographs for a visual binding diagnosis, require a certain outlay of materials, personnel, safety and time.

The control and evaluation device is set up to retrieve the temporal course of the detected values from the motor control device 13, to store it and, if the determined deviation exceeds a predeterminable threshold value, to check for faults, to categorize any fault which is found and to store the fault category locally and optionally to transfer it to the local display as well as to send a fault diagnosis report together with the temporal course of the detected values of the at least one motor characteristic to the data storage device 4 in the remote computer for storing and for carrying out an expanded remote fault diagnosis. The fault diagnosis report can additionally or alternatively also be sent to a participant, which, in the present example, is a computer 5 and has a display device 6, of the data network 16. As can be seen from the right side of FIG. 1, the communication module 14 is set up to check the availability of firmware updates for the motor control device 13 and/or for connected peripheral devices and to transmit firmware updates to the motor control device 13 and/or in a wireless manner to the peripheral devices.

Additionally or alternatively, the or a participant of the data network 16 can be used for this purpose, for example.

The communication module 14 is further set up to ensure that usage and height adjustment data from the table 1 and/or utilization data of the table 1 are stored in the data storage device 4 of the remote computer.

Advantageously, the communication module 14 has at least one radio interface, such as WLAN, Bluetooth, Zigbee or NFC interfaces, for example, for communicating with peripheral devices and for communicating with a participant of the data network via the data network 16.

FIG. 2 shows, by way of example and schematically, a table leg 12 of the table from FIG. 1 as well as the electric motor (drive motor) 121 and a spindle drive (122). In connection with the sensor device 17, a normal operation (FIG. 2 right) but also an operation which deviates from normal operation (FIG. 3 right) can be identified by means of the temporal courses of current and speed (of the height adjustment) with in this case constant voltage at the beginning of the movement of the table top. This is represented schematically once on the right side of FIG. 3 in the case of spindle wear 127. If an anomaly 128 of this type is found, the communication module 14 can output a corresponding warning message and/or a maintenance note via a suitable display device, for example. Alternatively or additionally, the height adjustment function can be locked for safety reasons, for example.

During the measurement phase, characterized in FIG. 2 and in FIG. 3, current, voltage and speed curves are measured and stored depending on the time, for example. The average values of the respective curves at the end of a movement are stored in the control and evaluation device and transferred to the data storage device 4 via the communication module 14, for example. Parallel thereto, a comparison of the respective temporal courses takes place during the measurement phase with a predeterminable threshold value. In the event of exceeding (FIG. 3), the temporal courses at the end of the relevant movement are stored in the control and evaluation device and transferred to the data storage device 4 via the communication module 14. The temporal analysis of the current curve offers the possibility, for example, of localizing and remedying a mechanical resistance, for example spindle wear 127, in the case of the spindle drive 122. Fault archiving and categorizing offers the possibility in the future of identifying the cause of the fault (e.g. maloperation, damage in transit, a production defect, material quality, and the like) more quickly.

FIG. 4 represents a flow diagram of a method for carrying out a local fault diagnosis and optionally an expanded remote fault diagnosis according to one particular embodiment of the present invention. After receiving a movement command (S121), the motor control device 13 outputs a command in order to move the table in the corresponding direction (S122). After the end of the movement, motor data detected by means of sensor devices, such as motor current and Hall sensor pulses, for example, are stored, averaged and evaluated in the control and evaluation device (S123). If the motor data exceed a threshold value, the control and evaluation device reports an anomaly (S124) which triggers a local check of the temporal recording of the motor data (S125) and sends a fault diagnosis report with detailed progress of the motor data and categorization of the fault to the central data storage device 4 (S126). The user of the table is then informed about the category of the anomaly and about an appropriate measure for remedying the anomaly or the fault on the table display (153) (S127). Lastly, the motor data are stored in the log file of the motor control device.

FIG. 5 shows details of an example of an operating device 15. In this case, it can be a so called manual switch. In this example, the operating device 15 has an operating element 151 for raising and an operating element 152 for lowering the table top. In addition, a high resolution display 153 can be provided.

Furthermore, the operating device can include the communication module 14 or parts thereof, wherein it is characterized here with the reference number 154, and an NFC reader 155.

The display 153 can, for example, serve to display the booking information of the workstation and/or the table height, a note on performing a physical activity, such as standing up, for example, and/or a status message and/or fault message of the workstation.

The NFC reader 155 can serve to read an authorization means, such as a user chip card (not shown), for example, and to check whether the user is authorized, for example based on a remote login or remote booking, to use the table 1 or workstation. The remote booking may have been made via a participant of the data network 16 with the remote computer, for example.

FIG. 6 represents a flow diagram of a method for allocating workstations in a data-driven manner (see FIG. 7). The initial situation of a space A (S131) is compared with data of the space utilization of the respective workstations APi (AP1, AP2, AP3 and AP4) (S132). FIG. 7 represents the respective space data per member of staff Mj (M1, M2 and M3). The usage of a workstation APi by a member of staff Mj is defined as variable DTij (see FIG. 7). Allocating a member of staff Mj to a specific workstation APi takes place in the event of exceeding the utilization DTij>DTi (reference value for minimum usage of a workstation). FIG. 7 shows an allocation of four workstations by evaluating the utilization via three members of staff with the exemplary threshold value DTi=50%. FIG. 8 shows a filtering of sensor data via a table group of four workstations. In this example, a categorization takes place via the height of the measured sound pressure level at the workstation in dB. In this case, the workstation AP4 is characterized as ‘too loud’. After a successful allocation of a workstation to a member of staff (represented in FIG. 7), FIG. 9 represents attributes of a usage of the table (current table height) by the member of staff and presence information of the member of staff (place where the member of staff is located, and availability for a conversation).

By way of example, FIG. 10 represents two electrically height-adjustable table legs 12 and a motor control device 13 with a communication module 14. A computer 5 with a display device 6 can exchange information, such as table height, or motor data, for example, and commands, such as raising or lowering, for example, with the motor control device 13 via a data interface, such as a USB cable or other so called human interface devices (HID) cables, for example. The user can interact more successfully and more easily with a height-adjustable furniture system, such as the furniture system 1000 from FIG. 1, for example, via an operation software 61 which is preinstalled in the computer 5. The user must firstly register themselves in the system for the first time, which can take place via the operation software (desktop app) 61, for example (611). Personal parameters, such as preferred sitting height and standing height or weight for calculating calories burned, for example, can be input here for setting up the user profile 611. These user data 63 are transmitted to the data storage device (e.g. cloud database) 4 via a wireless protocol, such as http, for example. The availability of these user data 63 in a cloud database 4 ensures that personal user parameters can be retrieved irrespective of the desktop computer or connected height-adjustable tables. Retrieving data in this way takes place after login 612 through the same desktop app 61 via login and password. The user can optionally choose to remain logged in on the computer 5 with the operation software 61, which allows a direct user identification after the computer is started up. After a successful login of a user, the height-adjustable table can be operated via the operation software 61 with personal settings (613).

In FIG. 11 (left), an operating device 15 is connected to the motor control device 13 and is characterized on the right. The operating device 15 serves as an interface for the control of the height-adjustable table, as well as, among other things, for storing preferred table heights. A user login, for example via RFID, is possible by way of the NFC reader 155. After detection via the reader, the ID number is transmitted to the cloud database 4 via a communication module 154 and compared in the user database. After identifying the user, user settings, such as preferred table heights, for example, are transmitted to and stored in the operating device.

By way of example, FIG. 12 represents a method for user login (S611), both via operation software 61 and via RFID card. A user is identified via login and password by means of the desktop app (S612), which login and password can be input directly via the desktop app or via a web platform for an initial registration. In the case of RFID cards, these cards are firstly distributed to the users by the administrator of the interface and are connected to the user accounts. The input of login data or the RFID number is transferred wirelessly to the database and is checked there (S613). Non-existing or non-authorized users result in the display “user unknown” or “user not authorized” (S617), for example. In the case of valid users, the user data are retrieved from the database and transmitted to the operating device 15 in the case of RFID login or to the operation software 61 in the case of login/password login. The user is reallocated the workstation in the booking system (S615) and is displayed on the display of the operating device 153 (S616).

FIG. 13 shows a part of a furniture system 1300. Not shown is an electrically height-adjustable table which has at least one electrically height-adjustable frame, in particular an electrically height-adjustable table leg, with at least one electric motor via which a height adjustment is possible, a motor control device for controlling the at least one electric motor and a radio communication module which is connected to the motor control device. However, an associated chair 3 with a in this example 3-axis acceleration sensor 32 as well as an evaluation unit connected thereto for evaluating the temporal course of the acceleration, which is detected by means of the acceleration sensor 32, in the vertical direction (z direction), for determining whether a user 2 has sat down on the chair 3 or has stood up from it, and a radio communication module 30, which is connected to the evaluation unit, for sending a command signal to the motor control device 13, for example, via the radio communication module of the table, wherein the command signal serves to automatically raise the table top if the evaluation has shown that the user 2 has changed from a sitting position to a standing position (see the process indicated in FIG. 13 left), and serves to automatically lower the table top if the evaluation has shown that the user 2 has changed from a standing position to a sitting position (see the upward movement of the user 2 in FIG. 13 right).

As shown in FIG. 14, a position change can be determined based on the time-dependent acceleration behavior of the chair or the seat. In the left part of the graph in FIG. 14, the temporal behavior of the acceleration when sitting down is shown by way of example, while in the right part of the graph, the temporal behavior of the acceleration when standing up is shown by way of example.

By way of example, FIG. 15 illustrates a method for automatically adjusting the height of the table top of an electrically height-adjustable table according to one particular embodiment of the present invention by means of a flow diagram. When the chair (e.g. chair 3) is in a rest position (S141) and after receiving an initialization signal (S142, e.g. via the table control (e.g. operating device 15)), the acceleration sensor, for example acceleration sensor 32, is calibrated so that the position of the chair and the z direction is identified via an evaluation of the force of gravity in the rest position of the chair (S143). A movement of the chair triggers a pulse, for example by way of an energy saving vibration sensor (S144), which is provided for waking up a detection module (e.g. detection module 300) which is mounted under the chair (S145). The temporal recording of the acceleration is evaluated (S146) and reported for the purpose of monitoring an undesired presence (S147). In the event of exceeding a threshold value of the acceleration in the z direction, as represented in FIG. 14 by way of example, the sitting position of the user is reported back to the control and stored in a database (S148). The detection of a sitting down movement triggers the movement of the table into a ‘sitting’ position or the detection of a standing up movement triggers the movement of the table into a ‘standing’ position. The detection module then goes into a ‘light sleep’ (S149) and records the movement values of the user or the chair. Exceeding a threshold value of the acceleration in the z direction (S150), as represented in FIG. 14 by way of example, triggers a radio message that the chair has been vacated (S151), whereby the detection module finally goes into a “deep sleep” (S152).

1. A furniture system (1000) with
an electrically height-adjustable table (1) which has at least one electrically height-adjustable frame, in particular an electrically height-adjustable table leg (12), with at least one electric motor (121) via which a height adjustment of the table top (11) is possible, and a motor control device (13) for controlling the at least one electric motor (121) as well as at least one sensor device (17) for temporally detecting a value of at least one motor characteristic of the at least one electric motor (121),
a communication module (14) with a control and evaluation device, which is coupled to the at least one sensor device (17), for evaluating the values of the at least one motor characteristic, which values are detected by means of the at least one sensor device (17), with regard to a deviation from a respective motor characteristic reference value, which communication module is coupled to the motor control device (13) via a data connection, and
a remote computer, in particular server, preferably with a web interface, which can be connected to the communication module (14) via a data network (16) and has a data storage device (4) as well as means for expanded remote fault diagnosis for the at least one electrically height-adjustable table (1),
wherein the motor control device (13) is coupled to the at least one sensor device (17) and is set up to store the detected values of the at least one motor characteristic, and wherein the control and evaluation device is set up to retrieve the temporal course of the detected values from the motor control device (13), to store it and, if the determined deviation exceeds a predeterminable threshold value, to check for faults, to categorize any fault which is found and to store the fault category locally and optionally to transfer it to the local display as well as to send a fault diagnosis report together with the temporal course of the detected values of the at least one motor characteristic to the data storage device (4) in the remote computer for storing and for carrying out an expanded remote fault diagnosis.

2. The furniture system (1000) as claimed in claim 1, wherein the data network (16) is a public network, an intranet and/or the internet.

3. The furniture system (1000) as claimed in claim 1 or 2, wherein the participant is a computer and/or a mobile device, in particular mobile phone or tablet PC.

4. The furniture system (1000) as claimed in one of claims 1 to 3, wherein the communication module (14) is set up to lock or to unlock at least one functionality of the table (1), in particular depending on at least one criterion.

5. The furniture system (1000) as claimed in one of the preceding claims, wherein the communication module (14) is set up to check the availability of firmware updates for the motor control device (13) and/or for connected peripheral devices and to transmit firmware updates to the motor control device (13) and/or in a wireless manner to the peripheral devices.

6. The furniture system (1000) as claimed in one of the preceding claims, wherein the communication module (14) is set up to ensure that usage and height adjustment data from the table (1) and/or utilization data of the table (1) are stored in the data storage device (4) of the remote computer.

7. The furniture system (1000) as claimed in one of the preceding claims, wherein the communication module (14) is set up to retrieve booking data relating to the table from the data storage device (4) of the remote computer.

8. The furniture system (1000) as claimed in one of the preceding claims, wherein the communication module (14) has at least one radio interface, such as a WLAN, Bluetooth, Zigbee and NFC interface, for example, for communicating with peripheral devices and for communicating with a participant of the data network via the data network (16).

9. The furniture system (1000) as claimed in one of the preceding claims, wherein the sensor device further has at least one sensor for detecting air quality and/or at least one sensor for detecting brightness and/or at least one sensor for detecting noise and/or at least one sensor for detecting temperature and/or at least one sensor for detecting humidity in the environment of the table (1).

10. The furniture system (1000) as claimed in one of the preceding claims, wherein the communication module (14) is contained in the motor control device (13) or is arranged in a housing in which the motor control device (13) is contained.

11. The furniture system (1000) as claimed in one of claims 1 to 9, wherein the communication module (14) is contained in an operating device (15) for height adjustment, in particular a manual switch, or is arranged in a housing in which the operating device (15) is contained.

12. The furniture system (1000) as claimed in claim 11, wherein the operating device (15) has a display (153), preferably with a high resolution, for displaying the fault category and/or a fault diagnosis report and/or the table height and/or a reminder of the setting of an ergonomic sitting or standing position and/or a reminder of a position change from sitting to standing and vice versa and/or the detected air quality and/or the detected brightness and/or the detected noise and/or the detected temperature and/or the detected humidity in the environment of the table (1).

13. The furniture system (1000) as claimed in claim 11 or 12, wherein the operating device (15) has an NFC reader (155) for reading an authorization means for a user (2) to use a table (1).

14. A method for carrying out a local fault diagnosis and optionally an expanded remote fault diagnosis for at least one electrically height-adjustable table (1) which has at least one electrically height-adjustable frame, in particular an electrically height-adjustable table leg (12), with at least one electric motor (121) via which a height adjustment of the table top (11) is possible, and a motor control device (13) for controlling the at least one electric motor (121) as well as at least one coupled sensor device (17), which is coupled to the motor control device, for temporally detecting a value of at least one motor characteristic of the at least one electric motor (121), wherein the method comprises the steps:
temporally detecting values of at least one motor characteristic of the at least one electric motor (121) by means of at least one sensor device (17) and storing the detected values of the at least one motor characteristic of the motor control device,
evaluating the currently detected value in each case of the at least one motor characteristic with regard to a deviation from a respective motor characteristic reference value by means of a control and evaluation device, which is coupled to the motor control device, of a communication module (14) in the region of the table (1), and
if the determined deviation exceeds a predeterminable threshold value, carrying out, by way of the control and evaluation device, a check of the temporal course of the detected values, categorizing any fault which is found and storing the fault category locally and optionally transferring it to the local display as well as sending a fault diagnosis report together with the temporal course of the detected values of the at least one motor characteristic to a data storage device in a remote computer for storing and for carrying out an expanded remote fault diagnosis, sending a command signal for carrying out a remote analysis, remote maintenance and/or troubleshooting to the remote computer by means of the communication module (14) and after carrying out the remote analysis, remote maintenance and/or troubleshooting.

15. The method as claimed in claim 14, further comprising locking or unlocking a functionality of the table (1), in particular depending on at least one criterion, such as reaching a predeterminable degree of wear or the occurrence of a reduced or faulty function of the table, for example.

16. The method as claimed in claim 14 or 15, further comprising checking the availability of firmware updates for the motor control device (13) and/or for connected peripheral devices and transmitting firmware updates to the motor control device (13) and/or in a wireless manner to the peripheral devices.

17. A system for detecting the utilization of workstations with, preferably electrically height-adjustable, tables (1), comprising
means for detecting the use of the workstation and
an evaluation unit for calculating the utilization of the workstations.

18. The system as claimed in claim 17, further comprising
means for detecting environmental parameters, such as air quality, brightness, noise, temperature and humidity in the environment of the table (1), for example, of the respective workstation and/or
means for detecting the respective workstation equipment, in particular features of the workstation equipment.

19. The system as claimed in claim 17 or 18, further comprising means for subdividing the workstations into categories.

20. The system as claimed in one of claims 17 to 19, further comprising means for detecting the type of usage of the respective workstation, such as the use of the respective table (1) when sitting or when standing, for example, optionally also the temporal proportions of the respective use.

21. The system for allocating a free workstation which corresponds to user requests with a, preferably electrically height-adjustable, table (1), comprising
means for detecting the use of the workstations,
means for detecting the respective workstation equipment, in particular features of the workstation equipment, and/or for detecting environmental parameters, such as air quality, brightness, noise, temperature and humidity, for example, of the respective workstation,
means for inputting user requests with regard to the properties of a workstation,
means for comparing the user requests with the respective workstation equipment and/or environmental parameters and allocating a free workstation which most closely approximates the user requests.

22. The system as claimed in claim 21, wherein the user requests also comprise a date and a time period.

23. The system as claimed in claim 22, wherein allocation comprises a reservation.

24. The system as claimed in one of claims 21 to 23, further comprising means for subdividing the workstations into categories.

25. The system as claimed in one of claims 21 to 24, wherein for each workstation there is a means for checking the authorization of the use of the respective workstation.

26. The system for automatically setting user-specific settings for a workstation with a, preferably electrically height-adjustable, table (1), comprising
a means for establishing a user profile relating to user-specific settings for a workstation and optionally also user properties,
a means for reading data relating to the identity of a user (2) and
a means for automatically performing user-specific settings corresponding to the user profile which belongs to the identified user (2).

27. A furniture system (1300) with
an electrically height-adjustable table (1) which has at least one electrically height-adjustable frame, in particular an electrically height-adjustable table leg (12), with at least one electric motor (121) via which a height adjustment is possible, a motor control device (13) for controlling the at least one electric motor (121) and a radio communication module which is connected to the motor control device (13),
an associated chair (3) with a, preferably 3-axis, acceleration sensor (32) as well as an evaluation unit connected thereto for evaluating the temporal course of the acceleration, which is detected by means of the acceleration sensor (32), in the vertical direction, for determining whether a user (2) has sat down on the chair or has stood up from it, and a radio communication module (30), which is connected to the evaluation unit, for sending a command signal to the motor control device (13) via the radio communication module of the table (1), wherein the command signal serves to automatically raise the table top (11) if the evaluation has shown that the user (2) has changed from a sitting position to a standing position, and serves to automatically lower the table top (11) if the evaluation has shown that the user (2) has changed from a standing position to a sitting position.

The features of the invention disclosed in the preceding description, in the drawings as well as in the claims may be essential, both individually and in any combination, for the implementation of the invention in its various embodiments.

### LIST OF REFERENCE NUMBERS

1 height-adjustable table
2 user
3 chair
4 data storage device
5 computer
6 display device
11 table top
12 table leg
13 motor control device
14 communication module
15 operating device
16 data network
17 sensor device
30 radio communication module
31 seat
32 acceleration sensor
33 sitting
34 standing
51 firmware update/update over the air (OtA)
52 remote diagnosis via motor characteristic(s)
61 operation software
63 user data
121 electric motor
122 spindle drive
123 voltage curve
124 speed curve
125 current curve
126 status history
127 spindle wear 128 detected anomaly
151 operating function “up”
152 operating function “down”
153 display
154 communication module
155 NFC reader
300 detection module
331 temporal recording “sitting”
332 1. exceeding “sitting”
333 2. exceeding “sitting”
341 temporal recording “standing”
342 1. exceeding “standing”
343 2. exceeding “standing”
1000 furniture system
1300 furniture system

1. A furniture system (1000) with
an electrically height-adjustable table (1) which has at least one electrically height-adjustable frame, in particular an electrically height-adjustable table leg (12), with at least one electric motor (121) via which a height adjustment of the table top (11) is possible, and a motor control device (13) for controlling the at least one electric motor (121) as well as at least one sensor device (17) for temporally detecting a value of at least one motor characteristic of the at least one electric motor (121),
a, preferably permanently installed, communication module (14) with a control and evaluation device, which is coupled to the at least one sensor device (17), for evaluating the values of the at least one motor characteristic, which values are detected by means of the at least one sensor device (17), with regard to a deviation from a respective motor characteristic reference value, which communication module is coupled to the motor control device (13) via a data connection, and
a remote computer, in particular server, preferably with a web interface, which can be connected to the communication module (14) via a data network (16) and has a data storage device (4) as well as means for expanded remote fault diagnosis for the at least one electrically height-adjustable table (1),
wherein the motor control device (13) is coupled to the at least one sensor device (17) and is set up to store the detected values of the at least one motor characteristic, and wherein the control and evaluation device is set up to evaluate the currently detected value in each case of the at least one motor characteristic with regard to a deviation from a respective motor characteristic reference value and, if the determined deviation exceeds a predeterminable threshold value, to check the temporal course of the detected values, to categorize any fault which is found and to store the fault category locally and optionally to transfer it to the local display as well as to send a fault diagnosis report together with the temporal course of the detected values of the at least one motor characteristic to the data storage device (4) in the remote computer for storing and carrying out an expanded remote fault diagnosis.

2. The furniture system (1000) as claimed in claim 1, wherein the data network (16) is a public network, an intranet and/or the internet.

3. The furniture system (1000) as claimed in claim 1 or 2, wherein the participant is a computer and/or a mobile device, in particular mobile phone or tablet PC.

4. The furniture system (1000) as claimed in one of claims 1 to 3, wherein the communication module (14) is set up to lock or to unlock at least one functionality of the table (1), in particular depending on at least one criterion.

5. The furniture system (1000) as claimed in one of the preceding claims, wherein the communication module (14) is set up to check the availability of firmware updates for the motor control device (13) and/or for connected peripheral devices and to transmit firmware updates to the motor control device (13) and/or in a wireless manner to the peripheral devices.

6. The furniture system (1000) as claimed in one of the preceding claims, wherein the communication module (14) is set up to ensure that usage and height adjustment data from the table (1) and/or utilization data of the table (1) are stored in the data storage device (4) of the remote computer.

7. The furniture system (1000) as claimed in one of the preceding claims, wherein the communication module (14) is set up to retrieve booking data relating to the table from the data storage device (4) of the remote computer.

8. The furniture system (1000) as claimed in one of the preceding claims, wherein the communication module (14) has at least one radio interface, such as a WLAN, Bluetooth, Zigbee and NFC interface, for example, for communicating with peripheral devices and for communicating with a participant of the data network via the data network (16).

9. The furniture system (1000) as claimed in one of the preceding claims, wherein the sensor device further has at least one sensor for detecting air quality and/or at least one sensor for detecting brightness and/or at least one sensor for detecting noise and/or at least one sensor for detecting temperature and/or at least one sensor for detecting humidity in the environment of the table (1).

10. The furniture system (1000) as claimed in one of the preceding claims, wherein the communication module (14) is contained in the motor control device (13) or is arranged in a housing in which the motor control device (13) is contained.

11. The furniture system (1000) as claimed in one of claims 1 to 9, wherein the communication module (14) is contained in an operating device (15) for height adjustment, in particular a manual switch, or is arranged in a housing in which the operating device (15) is contained.

12. The furniture system (1000) as claimed in claim 11, wherein the operating device (15) has a display (153), preferably with a high resolution, for displaying the fault category and/or a fault diagnosis report and/or the table height and/or a reminder of the setting of an ergonomic sitting or standing position and/or a reminder of a position change from sitting to standing and vice versa and/or the detected air quality and/or the detected brightness and/or the detected noise and/or the detected temperature and/or the detected humidity in the environment of the table (1).

13. The furniture system (1000) as claimed in claim 11 or 12, wherein the operating device (15) has an NFC reader (155) for reading an authorization means for a user (2) to use a table (1).

14. A method for carrying out a local fault diagnosis and optionally an expanded remote fault diagnosis for at least one electrically height-adjustable table (1) which has at least one electrically height-adjustable frame, in particular an electrically height-adjustable table leg (12), with at least one electric motor (121) via which a height adjustment of the table top (11) is possible, and a motor control device (13) for controlling the at least one electric motor (121) as well as at least one coupled sensor device (17), which is coupled to the motor control device, for temporally detecting a value of at least one motor characteristic of the at least one electric motor (121), wherein the method comprises the steps:
temporally detecting values of at least one motor characteristic of the at least one electric motor (121) by means of at least one sensor device (17) and storing the detected values of the at least one motor characteristic of the motor control device,
evaluating the currently detected value in each case of the at least one motor characteristic with regard to a deviation from a respective motor characteristic reference value by means of a control and evaluation device, which is coupled to the motor control device, of a communication module (14) in the region of the table (1), and
if the determined deviation exceeds a predeterminable threshold value, carrying out, by way of the control and evaluation device, a check of the temporal course of the detected values, categorizing any fault which is found and storing the fault category locally and optionally transferring it to the local display as well as sending a fault diagnosis report together with the temporal course of the detected values of the at least one motor characteristic to a data storage device in a remote computer for storing and optionally carrying out an expanded remote fault diagnosis, optionally sending a command signal for carrying out an expanded remote fault diagnosis to the remote computer by means of the communication module (14) and
after carrying out the expanded remote fault diagnosis,
carrying out remote maintenance and/or troubleshooting.

15. The method as claimed in claim 14, further comprising locking or unlocking a functionality of the table (1), in particular depending on at least one criterion, such as reaching a predeterminable degree of wear or the occurrence of a reduced or faulty function of the table, for example.

16. The method as claimed in claim 14 or 15, further comprising checking the availability of firmware updates for the motor control device (13) and/or for connected peripheral devices and transmitting firmware updates to the motor control device (13) and/or in a wireless manner to the peripheral devices.

17. A system for detecting the utilization of workstations with, preferably electrically height-adjustable, tables (1), comprising
means for detecting the use of the workstation and
an evaluation unit for calculating the utilization of the workstations.

18. The system as claimed in claim 17, further comprising
means for detecting environmental parameters, such as air quality, brightness, noise, temperature and humidity in the environment of the table (1), for example, of the respective workstation and/or
means for detecting the respective workstation equipment, in particular features of the workstation equipment.

19. The system as claimed in claim 17 or 18, further comprising means for subdividing the workstations into categories.

20. The system as claimed in one of claims 17 to 19, further comprising means for detecting the type of usage of the respective workstation, such as the use of the respective table (1) when sitting or when standing, for example, optionally also the temporal proportions of the respective use.

21. The system for allocating a free workstation which corresponds to user requests with a, preferably electrically height-adjustable, table (1), comprising
means for detecting the use of the workstations,
means for detecting the respective workstation equipment, in particular features of the workstation equipment, and/or for detecting environmental parameters, such as air quality, brightness, noise, temperature and humidity, for example, of the respective workstation,
means for inputting user requests with regard to the properties of a workstation,
means for comparing the user requests with the respective workstation equipment and/or environmental parameters and allocating a free workstation which most closely approximates the user requests.

22. The system as claimed in claim 21, wherein the user requests also comprise a date and a time period.

23. The system as claimed in claim 22, wherein allocation comprises a reservation.

24. The system as claimed in one of claims 21 to 23, further comprising means for subdividing the workstations into categories.

25. The system as claimed in one of claims 21 to 24, wherein for each workstation there is a means for checking the authorization of the use of the respective workstation.

26. The system for automatically setting user-specific settings for a workstation with a, preferably electrically height-adjustable, table (1), comprising
means for establishing a user profile relating to user-specific settings for a workstation and optionally also user properties,
means for reading data relating to the identity of a user (2) and
means for automatically performing user-specific settings corresponding to the user profile which belongs to the identified user (2).

27. The system as claimed in claim 26, wherein the means for reading data relating to the identity of a user is designed to transmit the identity of the user via a wireless communication protocol, such as Bluetooth, for example.

28. The system as claimed in claim 26, wherein the means for reading data relating to the identity of a user is designed to transmit the identity of the user via a near-field protocol, such as RFID, for example.

29. The system as claimed in one of claims 26 to 28, wherein the means for automatically performing user-specific settings is designed to generate a motor command after confirmation of a user login or disconnection.

30. The system as claimed in claim 29, wherein the confirmation of a user login or disconnection takes place via at least one vibration of at least one motor.

31. The system as claimed in claim 29 or 30, wherein the confirmation of a user login or disconnection is designed to trigger a movement command to a previously saved position.

32. A furniture system (1300) with
an electrically height-adjustable table (1) which has at least one electrically height-adjustable frame, in particular an electrically height-adjustable table leg (12), with at least one electric motor (121) via which a height adjustment is possible, a motor control device (13) for controlling the at least one electric motor (121) and a radio communication module which is connected to the motor control device (13),
an associated chair (3) with a, preferably 3-axis, acceleration sensor (32) as well as an evaluation unit connected thereto for evaluating the temporal course of the acceleration, which is detected by means of the acceleration sensor (32), in the vertical direction, for determining whether a user (2) has sat down on the chair or has stood up from it, and a radio communication module (30), which is connected to the evaluation unit, for sending a command signal to the motor control device (13) via the radio communication module of the table (1), wherein the command signal serves to automatically raise the table top (11) if the evaluation has shown that the user (2) has changed from a sitting position to a standing position, and serves to automatically lower the table top (11) if the evaluation has shown that the user (2) has changed from a standing position to a sitting position.

33. The furniture system (1300) as claimed in claim 32, wherein the evaluation device is set up to send a warning signal to the communication module (14) of the table (1) via the radio communication module (30) if the evaluation of the data from the acceleration sensor has determined a non-authorized movement of the chair (3), and the table (1) or the furniture system (1300) has a warning device for outputting an optical and/or acoustic warning message upon receiving the warning signal from the chair (3).

34. The furniture system (1300) as claimed in claim 32 or 33, wherein the acceleration sensor or a further sensor device is set up to detect the duration of the sitting position, and the evaluation unit is set up to send a position change indication signal to the communication module (14) of the table (1) if the evaluation of the data from the acceleration sensor or the further sensor device has shown that the duration of the sitting position has exceeded a predeterminable temporal threshold value, and the table (1) or the furniture system (1300) has a position change indicator for outputting an optical and/or acoustic position change indication upon receiving the position change indication signal from the chair (3).

35. A method for automatically adjusting the height of the table top (11) of an electrically height-adjustable table (1), which has at least one electrically height-adjustable frame, in particular an electrically height-adjustable table leg (12), with at least one electric motor (121) via which a height adjustment is possible, a motor control device (13) for controlling the at least one electric motor (121) and a communication module (14) which is connected to the motor control device (121), when a user (2) changes position from a standing position to a sitting position, or vice versa, wherein the method comprises:
detecting the acceleration of a chair (3) which is associated with the table (1),
evaluating the temporal course of the detected acceleration in the vertical direction for determining whether a user (2) has sat down on the chair or has stood up from it, and
sending a command signal to the motor control (121), wherein the command signal includes that the table top (11) should be automatically raised if the evaluation has shown that the user has changed from a sitting position to a standing position, and the command signal includes that the table top (11) should be automatically lowered if the evaluation has shown that the user has changed from a standing position to a sitting position.
